(19) United States
(12) Patent Application Publication
(10) Pub. No.: US 2025/0030818 A1
(43) Pub. Date: Jan. 23, 2025

(54) METHOD FOR VIDEO CALL SESSION AND APPARATUS, ELECTRONIC DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventors: Fahui ZENG, Shenzhen (CN); Dan HE, Shenzhen (CN); Shu-Hui CHOU, Shenzhen (CN); Liqiang LIU, Shenzhen (CN); Xiong HE, Shenzhen (CN)

(21) Appl. No.: 18/906,297

(22) Filed: Oct. 4, 2024

Related U.S. Application Data
(63) Continuation of application No. PCT/CN2023/125891, filed on Oct. 23, 2023.

(30) Foreign Application Priority Data
Dec. 24, 2022 (CN) 202211669442.6

(51) Int. Cl. H04N 7/15; H04N 7/14

(52) U.S. Cl. CPC H04N 7/157; H04N 7/147

(57) ABSTRACT

Embodiments of this application disclose a method for video call session and apparatus, an electronic device, a storage medium, and a program product. The method includes displaying a first video call session interface on a first client participating in a video call session, a first virtual object corresponding to the first client in the first video call session interface; recognizing a first movement of a first user in a first image, the first image being an image collected by the first terminal when the first terminal faces the first user; and controlling the first virtual object in the first video call session interface to perform the first movement.

### RELATED APPLICATIONS

This application is a continuation of PCT Application No. PCT/CN2023/125891, filed on Oct. 23, 2023, which claims priority to Chinese Patent Application No. 202211669442.6, entitled “METHOD FOR VIDEO CALL SESSION AND APPARATUS, ELECTRONIC DEVICE, AND STORAGE MEDIUM” filed with the China National Intellectual Property Administration on Dec. 24, 2022. The two applications are both incorporated by reference in their entirety.

### FIELD OF THE TECHNOLOGY

This application relates to the field of instant messaging technologies, and more specifically, to a method for video call session and apparatus, an electronic device, a storage medium, and a program product.

### BACKGROUND OF THE DISCLOSURE

With the development of instant messaging technology, instant messaging is increasingly used in daily life, such as in a voice session and a video call session. In related art, in some video call session scenarios, a user may not want to participate in a video call session with a real image.

### SUMMARY

In view of the above problems, embodiments of this application provide a method for video call session and apparatus, an electronic device, a storage medium, and a program product, to resolve a problem that a user does not want to participate in a video call session with a real image in related art.

According to an aspect of embodiments of this application, a method for video call session is provided and performed by a first terminal. The method includes displaying a first video call session interface on a first client participating in a video call session, a first virtual object corresponding to the first client in the first video call session interface; recognizing a first movement of a first user in a first image, the first image being an image collected by the first terminal when the first terminal faces the first user; and controlling the first virtual object in the first video call session interface to perform the first movement.

According to an aspect of embodiments of this application, an electronic device is provided, including: a processor; and a memory, having computer-readable instructions stored therein, the computer-readable instructions, when executed by the processor, implementing the method for video call session described above.

According to an aspect of embodiments of this application, a non-transitory computer-readable storage medium is provided, having computer-readable instructions stored thereon, the computer-readable instructions, when executed by a processor, implementing the method for video call session described above.

### BRIEF DESCRIPTION OF THE DRAWINGS

Accompanying drawings herein are incorporated into the specification and constitute a part of this specification, show embodiments that conform to this application, and are used for describing a principle of this application together with this specification. Apparently, the accompanying drawings described below are merely some embodiments of this application, and a person of ordinary skill in the art may further obtain other accompanying drawings according to the accompanying drawings without creative efforts.

FIG. 1 is a schematic diagram of a scenario of this application according to an embodiment of this application.

FIG. 2 is a flowchart of a method for video call session according to an embodiment of this application.

FIG. 3 is a schematic diagram of entering a first video call session interface according to an embodiment of this application.

FIG. 4 is a flowchart of data processing of a sender and a recipient in a video call session according to an embodiment of this application.

FIG. 5A is a schematic diagram of processing data by a first client and a second client according to another embodiment of this application.

FIG. 5B is an example schematic diagram of a transmission channel provided by AVSDK in a first client and a second client.

FIG. 6 is a schematic diagram of anti-packet loss strategies in different network statuses according to an embodiment of this application.

Sections A to C of FIG. 7 are schematic diagrams of playing back animation in a first video call session interface according to an embodiment of this application.

Sections A to C of FIG. 8 are schematic diagrams of a first video call session interface according to an embodiment of this application.

FIG. 9 is a schematic diagram of a first video call session interface according to another embodiment of this application.

FIG. 10 is a schematic diagram of a first video call session interface according to another embodiment of this application.

FIG. 11A is a schematic diagram of displaying a first video call session interface in a zoomed-out manner according to an embodiment of this application.

FIG. 11B is an example curve of impacts of sound and screen asynchrony on human body's subjective experience and feelings under different time offsets.

FIG. 11C is a flowchart of processing data between a sender and a recipient according to an embodiment of this application.

FIG. 12 is a flowchart of operation A2 according to an embodiment of this application.

FIG. 13 is a block diagram of a video call session apparatus according to an embodiment of this application.

FIG. 14 is a schematic diagram of a structure of an electronic device for implementing an embodiment of this application.

### DESCRIPTION OF EMBODIMENTS

Embodiments of the present application are described more thoroughly with reference to the accompanying drawings below. However, the examples of implementations may be implemented in multiple forms, and it is not to be understood as being limited to the examples described herein. Instead, the embodiments are provided to make this application more thorough and complete and fully convey the idea of the embodiments to a person skilled in the art.

In addition, the described features, structures or characteristics may be combined in one or more embodiments in any appropriate manner. In the following descriptions, a lot of specific details are provided to give a comprehensive understanding of the embodiments of this application. However, a person of ordinary skill in the art is to be aware that the technical solutions in this application may be implemented without one or more of the particular details, or another method, unit, apparatus, or operation may be used. In other cases, well-known methods, apparatuses, implementations, or operations are not shown or described in detail, in order not to obscure the aspects of this application.

The term “plurality of” mentioned in the specification means two or more. “And/or” describes an association relationship between associated objects and represents that three relationships may exist. For example, A and/or B may represent the following three cases: Only A exists, both A and B exist, and only B exists. The character “/” generally indicates an “or” relationship between the associated objects.

Artificial Intelligence (AI) is a theory, a method, a technology, and an application system that uses a digital computer or a machine controlled by the digital computer to simulate, extend, and expand human intelligence, perceive an environment, obtain knowledge, and use knowledge to obtain an optimal result. An artificial intelligence technology may be used to perform movement recognition based on an image, such as body movement recognition and expression recognition. In the solution of this application, the artificial intelligence technology applied in movement recognition is applied to a video call session.

A video call session in the present disclosure may refer to any type of video sessions including any audio or video call sessions between two or more users or objects. In some embodiments, a video call session may be any video session initiated by one or more users to interact with each other. For example, a video call session may be a video session in an instant messaging application or in a computer game that is initiated between two or more users; a video call session may be a video session in an augmented reality environment or a virtual reality environment between two or more users or objects, etc. In summary, a video call session may refer to any type of video sessions with multiple users, and is not limited by the specific applications or environments described in this specification.

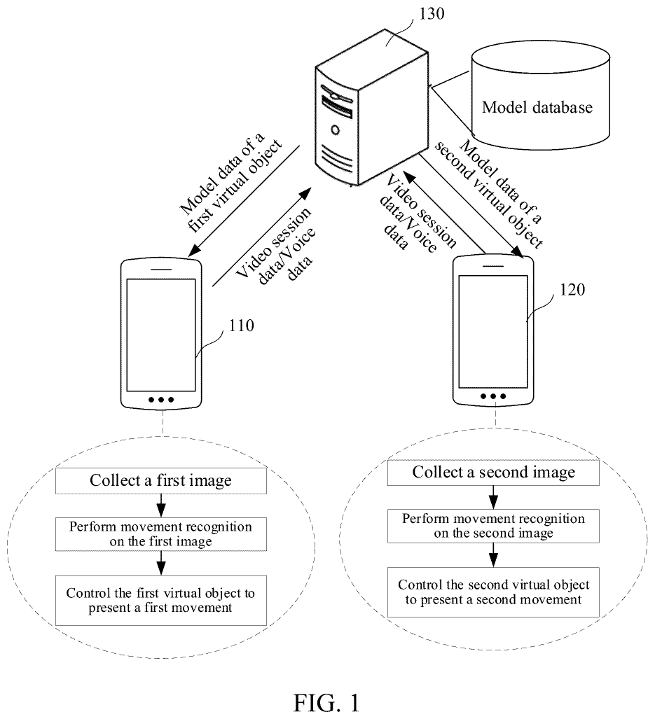

FIG. 1 is a schematic diagram of an environment of this application according to an embodiment of this application. As shown in FIG. 1, the environment includes a first terminal 110, a second terminal 120, and a server 130. The server 130 can provide an instant messaging service for a first client in the first terminal 110 and a second client in the second terminal 120. Further, the server 130 is provided with a model database. The model database includes model data of each virtual object and may further include model data of virtual scenes.

When the first client and the second client conduct a video call session according to the method in embodiments of this application, the first terminal 110 may obtain model data of a first virtual object and model data of a virtual scene from the server 130, to display the first virtual object and the corresponding virtual scene in a first video call session interface in the first client. The second terminal 120 may obtain model data of a second virtual object and scene data of a corresponding virtual scene from the server 130, to display the second virtual object and the corresponding virtual scene in a second video call session interface in the second client. Further, during the video call session between the first terminal and the second terminal, video call session data and voice data may be forwarded via the server 130.

In some embodiments, the first terminal 110 and the second terminal 120 are both provided with image collection apparatuses. During the video call session, image collection is performed in real time when the first terminal 110 and the second terminal 120 face users. In this case, the user is a real session object. Specifically, the first terminal 110 collects a first image, performs movement recognition on the first image, and controls the first virtual object to perform and present a first movement. In the same way, the second terminal collects a second image, performs movement recognition on the second image, and controls the second virtual object to perform and present a second movement. Accordingly, cross-screen video interaction between the first client and the second client is implemented, and a session between the first client and the second client is a video call session in which a real person does not participate.

The implementation details of the technical solution of embodiments of this application are described in detail in the following.

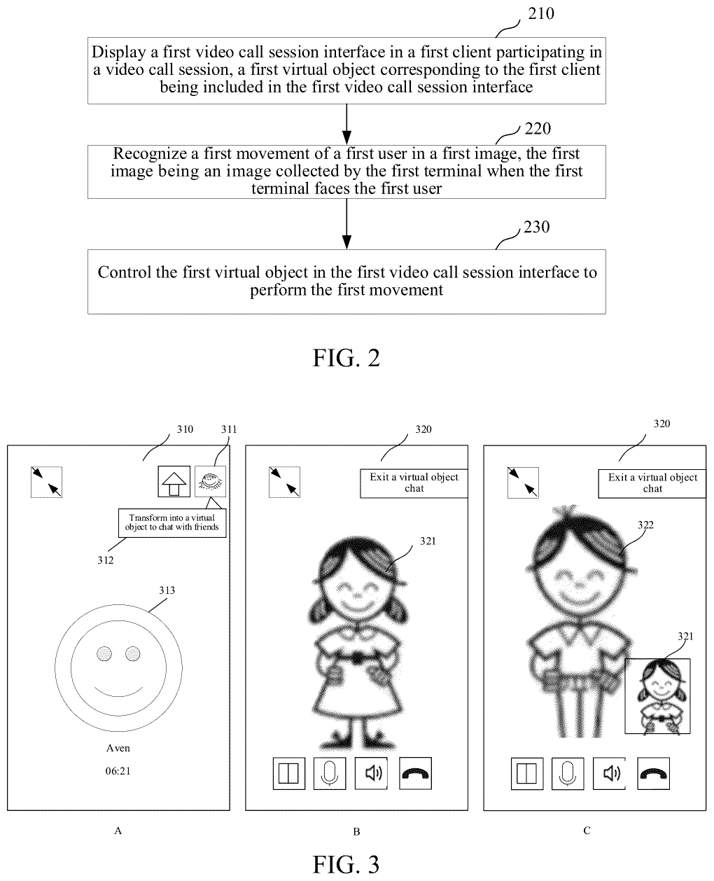

FIG. 2 is a flowchart of a method for video call session according to an embodiment of this application. The method may be performed by an electronic device, such as a smartphone, a tablet computer, a notebook computer, a desktop computer, a smart television, or another terminal that may run an instant messaging application, such as the terminal 110 and the terminal 120 shown in FIG. 1. More specifically, the method may be applied to a first client participating in a video call session. The first client may be a client of an instant messaging application or a client of another application having an instant messaging function. This is not specifically limited thereto. The video call session may be a session in which two users participate, or maybe a group session in which three or more users participate. This is not specifically limited thereto.

As shown in FIG. 2, the method includes at least operation 210 to operation 230. A detailed description is as follows:

Operation 210: Display a first video call session interface in the first client participating in the video call session, a first virtual object corresponding to the first client being included in the first video call session interface.

In some embodiments, a virtual object corresponding to the first client is referred to as the first virtual object. In some embodiments, the client provides a set of virtual objects for users to select. Based on this, a first user corresponding to the first client may select, from the set, a first virtual object that the first user likes or represents the first user. Then, after initiating the video call session, the first client may download model data of the first virtual object selected by the first user from a server. Then, rendering is performed based on the model data of the first virtual object, and the first virtual object obtained through rendering is displayed accordingly in the first video call session interface.

Further, the client may further provide a dressing collection. The dressing collection includes accessories, such as hair accessories, clothing, shoes, backpacks, hairstyles, glasses, and scarves, used to dress up virtual objects. This is not specifically limited thereto. The first client may alternatively obtain model data of an accessory selected for the first virtual object from the server, rendering is performed on the model data of the accessory selected for the first virtual object and the model data of the first virtual object, and the accessory and the first virtual object are displayed in the first video call session interface, to ensure that the accessory worn on the displayed first virtual object is the accessory selected by the first user for the first virtual object.

In some embodiments, a mode of a voice session or a regular video call session (that is, a video call during which a user portrait is displayed) may be switched to a mode of using a virtual object for a video call. In this case, before operation 210, the method further includes: displaying an initial session interface in response to a session initiation operation initiated to the second client, an entry control being included in the initial session interface. In this embodiment, operation 210 includes: displaying the first video call session interface in response to a trigger operation on the entry control.

The session initiation operation may be an operation for initiating a voice session. In this case, the session initiation operation may be a trigger operation (such as a click/tap operation) on a control that initiates the voice session. The session initiation operation may alternatively be an operation for initiating a regular video call session. In this case, the session initiation operation may be a trigger operation on a control that initiates the regular video call session.

In a case in which the session initiation operation is a trigger operation on a control that initiates the voice session, the initial session interface is correspondingly a voice session interface. Section A of FIG. 3 is a schematic diagram of a voice session interface 310. As shown in section A of FIG. 3, an avatar 313 and a nickname “Aven” that correspond to a user may be displayed in the voice session interface.

The entry control is a control used to enter a video call session by using a virtual object. For example, the entry control 311 is displayed in the voice session interface 310 shown in section A of FIG. 3. To be convenient for the user to know a function of the entry control, first prompt information 312 is displayed below the entry control 311. Content of the first prompt information 312 is “Transform into a virtual object and chat with friends”. The content of the first prompt information may alternatively be other information indicating the function of the entry control 311.

If the user triggers the entry control 311 in the voice session interface, a first video call session interface 320 may be displayed, as shown in section B of FIG. 3. If the first client is an initiator of the video call session, a virtual object 321 shown in section B of FIG. 3 is the first virtual object.

In the process from initiating a video call session by using a virtual object to before a session recipient accepts the video call session, only the virtual object corresponding to a video call session initiator is displayed in the first video call session interface 320.

After the video call session with the session recipient is established, the virtual object corresponding to the session initiator and the virtual object corresponding to the session recipient are displayed in the first video call session interface 320. As shown in section C of FIG. 3, virtual objects respectively corresponding to two clients are shown, that are, a first virtual object 321 corresponding to the first client and a second virtual object 322 corresponding to the second client.

In some other embodiments, a session control for using a virtual object to conduct a video call session may alternatively be provided in a session message interface with friends. In this case, if the user triggers the session control, the first video call session interface may be directly displayed without first entering the voice session interface or regular video call session interface, so that a path to the first video call session interface is shortened.

When initiating the video call session by using the virtual object, the client requests to turn on an image collection apparatus in a terminal in which the client is located (for example, to turn on a front camera of a smartphone), to perform image collection when the terminal faces the user in real time during the video call session by using the virtual object.

The first client may be the initiator of the video call session or the recipient of the video call session.

Operation 220: Recognize the first movement of a first user in a first image, the first image being an image collected by a first terminal when the first terminal faces the first user.

In some embodiments, for the convenience of distinction, an image collected, when the first terminal faces the first user during the video call session, by the first terminal in which the first client is located is referred to as the first image.

After initiating the video call session, the first terminal turns on the image collection apparatus, and image collection is performed in real time when the first terminal faces the first user at a first client side, to obtain the first image. The first user is a user who participates in the video call session at the first client side.

The first movement is a movement presented by the first user in the first image. The movement presented by the first user may be at least one of a body movement or a facial movement. The facial movement may be regarded as an expression, such as laughing, smile, or frown. The body movement may include gestures such as a hand raising gesture, a finger heart gesture, a nodding gesture, a shaking head gesture, and a peace gesture.

In an embodiment, operation 220 includes: performing key point extraction on the first user in the first image to obtain a first key point video frame corresponding to the first user; and determining the first movement based on the first key point video frame.

In some embodiments, a key point may also be referred to as a human body key point, and the key point may include a key point such as a joint key point (such as an elbow key point, a shoulder key point, a wrist key point, a knee key point) or a key point of each facial feature.

Specifically, Key point extraction may be performed on the first image by using a trained key point detection model, and a corresponding first key point video frame is outputted. The key point detection model is a model constructed through one or more neural networks, such as a convolutional neural network, a fully connected neural network, and a recurrent neural network. This is not specifically limited thereto.

The first key point video frame indicates the location of a detected key point in the first user in the first image. Because graphics formed by sequentially connecting key points are different under different movements, the first movement may be determined based on the graphics formed by sequentially connecting key points in the first key point video frame.

In some other embodiments, the first movement of the first user in the first image may be recognized by using a trained movement recognition model. The movement recognition model is a model constructed through one or more neural networks and configured to perform recognition.

Operation 230: Control the first virtual object in the first video call session interface to perform the first movement.

The first virtual object in the first video call session interface is controlled to perform the first movement, so that the first user in an environment drives the first virtual object to present the same movement, for example, to present the same body movement and to present the same expression. Accordingly, although the video call session is not conducted through a user' real image, user's movements during the video call session are truly expressed through a virtual object corresponding to the user, which makes the video call session more interesting and improves user experience.

During the video call session, the first terminal in which the first client is located performs image collection in real time when facing the first user. At different moments, the movements of the first user may be different. Therefore, movement recognition is performed, according to the above process of operation 220 to operation 230, on the first images collected at each moment. Then, the first virtual object in the first video call session interface is controlled to perform movement switching to ensure that movements presented by the first virtual object are consistent with movements of the first user in the environment.

In some embodiments, if no character (that is, the first user) is included in the first image, the first virtual object in the first video call session interface is controlled to perform a movement in a preset movement library or to keep a last movement.

In some embodiments, to improve the user experience, a virtual background may be further displayed in the first video call session interface, which is equivalent to placing the first virtual object in virtual space. Scene data of the virtual background may be obtained from the server. Virtual scenes of different virtual objects may be the same or different, and may be provided based on specific needs.

In some embodiments, during the video call session, the first virtual object of the first user participating in the video call session is displayed in the first video call session interface, and movement recognition is performed based on the first image collected when the first terminal faces the first user, and the first virtual object in the first video call session interface is controlled to perform the movement presented by the first user in the first image. Accordingly, human body driving is implemented, that is, the user in the environment drives the first virtual object in the first video call session interface to present the same movement, so as to make the first virtual object more vivid and make instant messaging more interesting. In some embodiments, in the case of video call sessions, the user may not want to conduct a session with a real image, and according to the solution of this application, the problem can be effectively resolved.

A client participating in the video call session further includes a second client. A second user corresponding to the second client is also displayed in the first video call session interface in the first client. In the same way, the first video call session interface is also displayed in the second client, and the first virtual object and the second virtual object are also displayed in the second video call session interface in the second client. After the first client recognizes the first movement of the first user in the first image, the first virtual object in the second video call session interface displayed in the second client performs and presents the first movement. Accordingly, it is ensured that the movement of the first virtual object in the first video call session interface displayed in the first client and the second client is consistent.

In some other embodiments, after the first movement of the first user in the first image is recognized, the first user in the second video call session interface displayed in the second client performs the first movement, and the second virtual object that is in the second video call session interface in the second client and that corresponds to the second client responds to the first movement presented by the first user. To be specific, after the second virtual object may automatically respond to the first movement presented by the first virtual object after determining the first movement presented by the first virtual object. For example, if the first movement presented by the first virtual object is a slap movement, the second virtual object may automatically present a slap movement in the second video call session interface in response to the slap movement presented by the first virtual object.

In some embodiments, a response movement set may be constructed. The response movement set includes a plurality of movement pairs. Each movement pair includes two movements responding to each other. The movement pairs are, for example, two movements that represent slap with each other, two movements that represent handshake with each other, or two movements that represent hug with each other. If it is determined that the first movement presented by the first user in the first image is a movement in the response movement set, according to the response movement set, the other movement than the first movement in a response movement pair including the first movement is used as a response movement to the first movement, and the second virtual object is driven to present the response movement to the first movement, so that the second virtual object automatically interacts with the first virtual object.

When the second virtual object in the second video call session interface in the second client automatically responds to the first movement presented by the first virtual object, the second client sends movement response information of the second virtual object to the first client. The movement response information is configured for indicating a response movement of the second virtual object for the first movement. Then, the second virtual object in the first video call session interface displayed in the first client also presents the response movement.

In some embodiments, a client participating in the video call session further includes a second client. A second virtual object corresponding to the second client is also displayed in the first video call session interface. After operation 210, the method further includes operation A1 and operation A2 described below. A detailed description is as follows.

Operation A1: Receive second video call session data of the second client, the video call session data including a second key point video frame corresponding to a second user, the second user being a user at a second client side, the second key point video frame being obtained by performing key point extraction on the second user in a second image, the second image being an image collected by the second terminal when the second terminal faces the second user during the video call session, and the second key point video frame being configured for indicating a second movement of the second user in the second image.

During a video call session between the first client and the second client, an image collection apparatus in the second terminal also performs image collection in real time when the second terminal faces the second user. In embodiments of this application, for the convenience of distinction, an image collected, when the second terminal faces the second user, by the image collection apparatus in a terminal in which the second client is located is referred to as the second image, and a movement presented by the second user in the second image is referred to as the second movement.

Similarly, the second client performs movement recognition based on the second image, determines the second movement presented by the second user in the second image, and controls the second virtual object in the first video call session interface displayed in the second client to present the second movement. For the process of movement recognition by the second client on the second user in the second image, reference may be made to the foregoing description. Details are not described herein again.

Because it is necessary to keep a screen in the first video call session interface displayed in the first client consistent with a screen in the second video call session interface displayed in the second client, the second client needs to send video call session data to the first client in real time, so that the first client can obtain the second key point video frame corresponding to the second image from the video call session data sent by the second client, so as to determine, based on the second key point video frame, the second movement presented by the second user in the second image.

Operation A2: Control, based on the second key point video frame, the second virtual object in the first video call session interface to perform the second movement.

Specifically, in operation A2, the second virtual object is re-rendered based on the second key point video frame and model data of the second virtual object, so that a re-rendered second virtual object presents the second movement. Then, the re-rendered second virtual object is displayed in the first video call session interface.

The model data of the second virtual object may be carried in video call session data sent by the second client to the first client for the first time after a video call session is established between the first client and the second client. After the first client obtains the model data of the second virtual object, the model data is cached to the first client locally. Accordingly, during a subsequent video call session, the second client does not need to repeatedly send the model data of the second virtual object to the first client. The first client uses the model data of the second virtual object in the cache and the second key point video frame to perform rendering, so that the amount of data transmission is reduced.

In this embodiment, because the second client transmits the second key point video frame corresponding to the second image to the first client, rather than the second image, and an amount of data of the second image is relatively larger than an amount of data of a key point video frame corresponding to the second image, according to the solution of this embodiment, the amount of data transmission can be reduced.

During the video call session, the first user and the second user are displayed in the first video call session interface of the first client and the second video call session interface of the second client. Moreover, the first user drives the first virtual object to perform a movement, the second user drives the second virtual object to perform a movement, and screen synchronization is implemented in the video call session interfaces of the first client and the second client. Therefore, cross-screen interaction can be achieved, to be specific, the movement of the first user can be mapped to the first virtual object in the first video call session interface of the first client, and can also be mapped to the first virtual object in the second video call session interface of the second client. In addition, the second user can respond through the second virtual object based on the movement of the first virtual object in the first video call session interface.

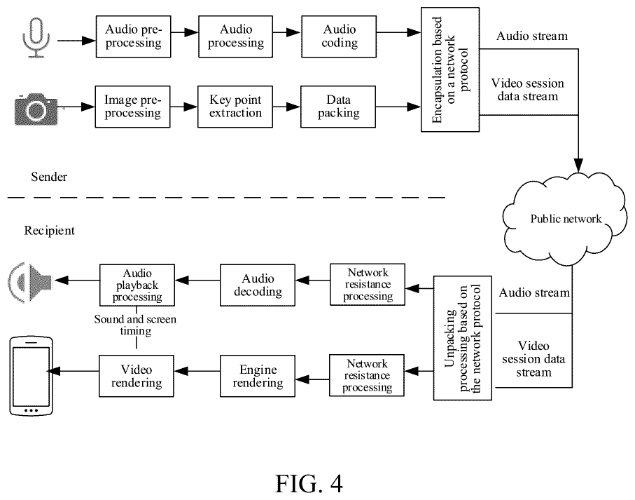

FIG. 4 is a flowchart of data processing of a sender and a recipient in a video call session according to an embodiment of this application. As shown in FIG. 4, during the video call session, the sender performs voice collection and image collection simultaneously.

For a collected voice, audio pre-processing, audio processing, and audio coding are performed in sequence, then encapsulation is performed based on a network protocol to obtain an audio stream, and the audio stream is transmitted to the recipient through a public network. The audio pre-processing may include performing acoustic echo cancellation (AEC), ambient noise suppression (ANS), and automatic gain control (AGC) on the voice. The audio processing may include performing mute monitoring on a voice after the audio pre-processing, or if a user chooses to change the voice, the voice may be further changed at this stage. At the audio coding stage, an output voice after the audio processing may be coded according to a preset audio coding strategy, for example, according to a silk audio coding strategy. During the encapsulation according to the network protocol, the audio may be encapsulated according to a corresponding anti-packet loss strategy, such as forward error correction (FEC).

At the sender side, for a collected image, image preprocessing, key point extraction, data packing, and encapsulation according to the network protocol are performed in sequence to obtain video call session data. The image pre-processing may include performing transcoding processing or size adjustment processing on the collected image. Then, the key point extraction is performed on an image after the image pre-processing to obtain a key point video frame. During the data packing, the key point video frame and model data of a virtual object may be packed. Then, data packet encapsulation is performed to obtain a video call session stream.

After the recipient receives the audio stream and video call session stream from the sender, network protocol unpacking processing is performed according to the corresponding network protocol. Then, for an audio stream after the network protocol unpacking processing, network resistance processing, audio decoding, and audio playback processing are performed in sequence. For the video call session data stream after the network protocol unpacking processing, network resistance processing, engine rendering, and video rendering are performed in sequence. In the engine rendering process, the virtual object may be rendered based on the model data of the virtual object. During the video rendering, rendering is performed based on the key point video frame to obtain a virtual object screen in which a corresponding movement is presented. Then, the virtual object screen is displayed.

Further, in the audio playback operation and the video rendering operation, sound and screen synchronization (or timing) processing is further performed. For the sound and screen synchronization processing, refer to the process of FIG. 12 below. Details are not described here again.

During the video call session, both the first client and the second client may act as the sender or the recipient. The first client and the second client both perform processing based on the process shown in FIG. 4 during the video call session.

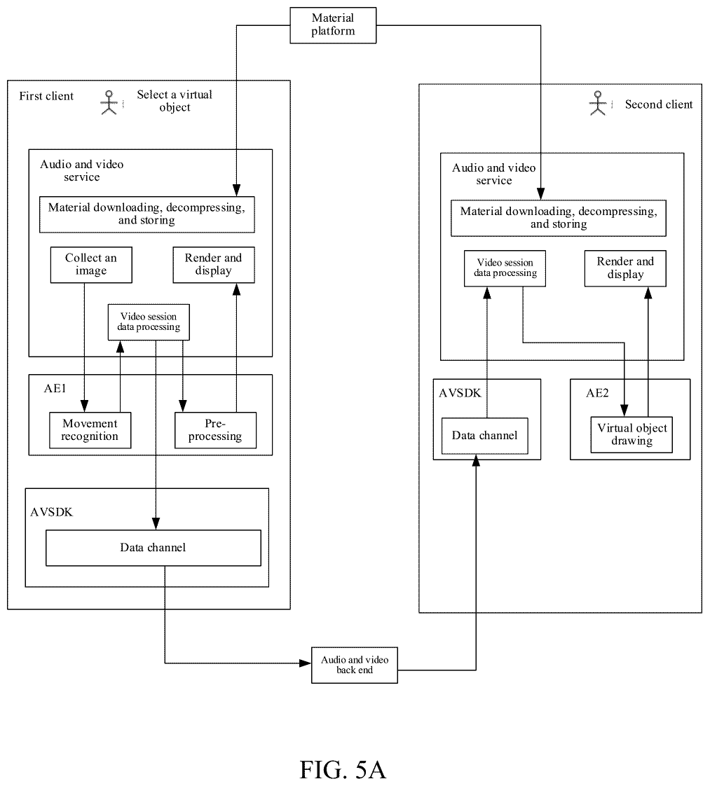

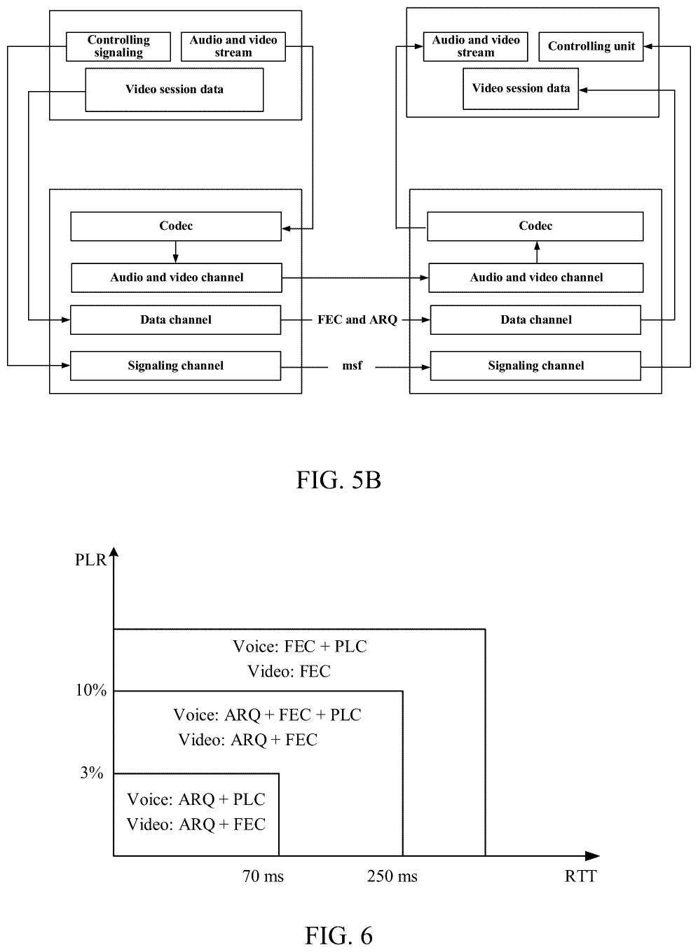

FIG. 5A is a schematic diagram of processing data by a first client and a second client according to another embodiment of this application. In FIG. 5A, for the convenience of description, it is assumed that the first client is a sender and the second client is a recipient. As shown in FIG. 5A, both the first client and the second client can download, decompress, and store model data from a material platform. The model data includes, for example, model data of a virtual object (such as 3D morphable model (3DMM) data), model data of a decoration, and background data of a virtual scene.

After collecting a first image, the first client performs movement detection and recognition to determine a first movement of a first user, performs video call session data processing based on the recognized first movement, pre-processes video call session data, and then performs rendering and displaying, to display, in a first video call session interface of the first client, a first virtual object presenting the first movement. In addition, the video call session data is sent to the second client through a data channel and an audio and video back end in AVSDK. The AVSDK refers to a software development kit (SDK) that provides a series of functions such as camera collection, coding, decoding, and beauty.

After receiving the video call session data, the second client performs the video call session data processing on the video call session data. Then, a virtual object is drawn based on the video call session data after the video call session data processing. Then, the first virtual object obtained through drawing is rendered on the screen to display, in a second video call session interface of the second client, the first virtual object presenting the first movement.

Because a data channel in the existing SDK is for transmitting a video stream, there is frame interpolation processing for audio and video frames. In the solution of this application, key point video frames need to be transmitted between the first client and the second client. However, this kind of data channel for transmitting the video stream is not suitable for transmitting the key point video frames, because frame interpolation processing on adjacent key point video frames is not required for the transmission of key point video frames. To resolve this problem, a data channel is added to the original transmission channel. The data channel is configured to transmit the video call session data in this application.

FIG. 5B is an example schematic diagram of a transmission channel provided by AVSDK in a first client and a second client. As shown in FIG. 5B, the AVSDK provides an audio and video channel (where the audio and video channel are originally configured to transmit audio data and video stream data), a data channel (that is, a new channel configured to transmit video call session data), and a signaling channel. In this embodiment, the audio and video channel are configured to transmit an audio stream in a video call session, the data channel is configured to transmit video call session data, and the signaling channel is configured to transmit a control instruction during the video call session.

In some embodiments, after the performing key point extraction on the first user in the first image to obtain a first key point video frame corresponding to the first user, the method further includes: encoding the first key point video frame to obtain video call session data corresponding to the first client; and sending the video call session data corresponding to the first client to the second client. The second client may control the first virtual object in the second video call session interface of the second client to present the first movement based on the first key point video frame, so as to ensure consistency of a screen in the video call session interface displayed in two parties of the video call session.

In some embodiments, the method further includes: determining a network status of the first terminal; and performing, according to an anti-packet loss strategy corresponding to a network status, data transmission protection on video call session data and voice data transmitted between the first terminal and the second terminal.

During the video call session, if the network status is poor, data (video call session data and voice data) transmitted between the two parties of the video call session may undergo a packet loss or a serious data delay. Therefore, to perform data transmission protection between the two parties of the video call session, anti-packet loss strategies under different network statuses are preset. The network status may be represented by at least one of round-trip time (RTT) and a packet loss rate (PLR).

The anti-packet loss strategy includes, for example, packet loss concealment (PLC), automatic repeat-request (ARQ), and forward error correction (FEC). The packet loss concealment means approximately replacing a current lost frame based on decoding information of a previous frame by using a method of pitch synchronization repetition, to achieve the packet loss concealment.

The automatic repeat-request refers to recovery of an error data frame by the recipient requesting the sender to retransmit a data frame in which an error occurs, sometimes referred to as backward error correction (BEC).

The forward error correction is a method that a data frame is encoded according to a specific algorithm in advance before being sent to a transmission channel, redundant code with characteristics of the data frame itself is added, and at a receive end, a received data frame is decoded according to a corresponding algorithm, to find out error code generated in a transmission process and correct the error code.

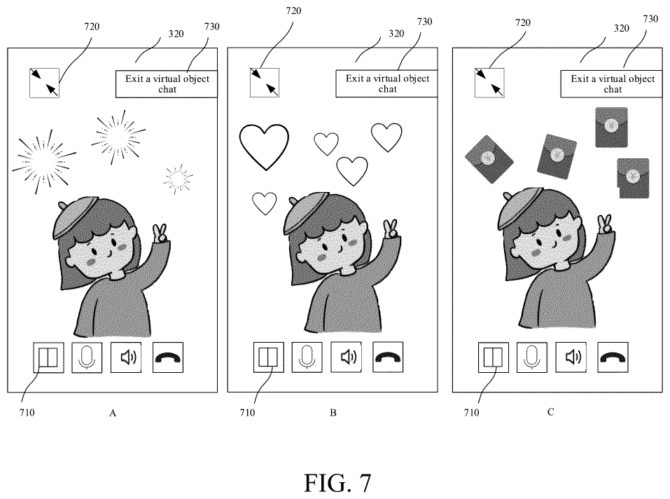

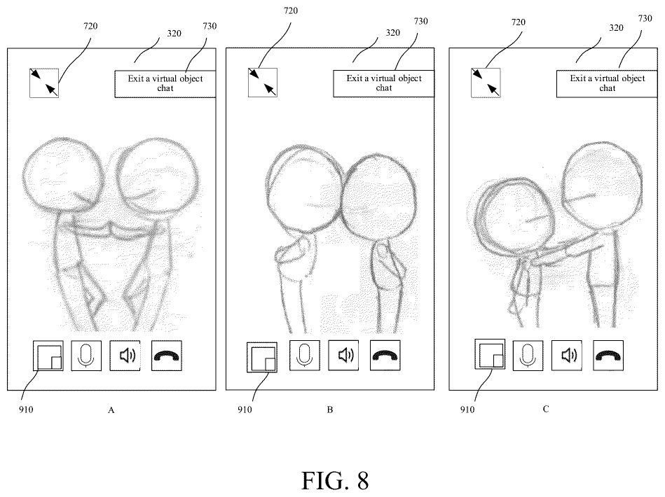

FIG. 6 is a schematic diagram of anti-packet loss strategies in different network statuses according to an embodiment of this application. As shown in FIG. 6, the network statuses are divided into three levels based on RTT and PLR.

If RTT<70 ms, or PLR<3%, the network status is in a first network status level, which indicates that the network status is excellent. In this case, for voice data, two anti-packet loss strategies, ARQ and PLC, are used. For video call session data, two anti-packet loss strategies, ARQ and FEC, are used. Specifically, ARQ may be mainly used, and FEC may be used for some key point video frames.

If 70 ms≤RTT<255 ms, or 3%≤PLR≤3%, the network status is in a second network status level, which indicates that the network status is good. In this case, for voice data, three anti-packet loss strategies, ARQ, FEC, and PLC, are used. For video call session data, two anti-packet loss strategies, ARQ and FEC, are used. Specifically, one of anti-packet loss strategies, ARQ and FEC, may be selected intelligently based on cost and user experience.

If RTT>255 ms, or PLR>10%, the network status is in a third network status level, which indicates that the network status is poor. In this case, for voice data, an anti-packet loss strategy, FEC, is used. For video call session data, two anti-packet loss strategies, FEC and PLC, are used. Specifically, in the case of large network delay or high packet loss rate, FEC is used instead of ARQ, because ARQ may further increase the delay in the case of weak network with the large delay or large packet loss.

In some embodiments, after operation 220, the method further includes: playing back, in the first video call session interface, animation corresponding to the first movement. In a specific embodiment, animation associated with each movement may be provided. Then, the animation associated with the first movement may be determined, that is, the animation corresponding to the first movement. Then, the animation corresponding to the first movement is played back based on animation data of the animation corresponding to the first movement. After determining the first movement of the first user in the first image, the animation corresponding to the first movement is also played back in the second video call session interface of the second client, so as to achieve consistency of screen content in the first client and the second client.

In some other embodiments, because animation may not be provided for each movement, animation may alternatively be provided for some movements, and movements provided with animation are added to a movement set. In this case, the method further includes: playing back animation corresponding first movement in the first video call session interface if the first movement is a movement in a preset movement set; or playing back animation corresponding to the second movement in the first video call session interface if the second movement is a movement in a preset movement set.

The preset movement set includes a plurality of movements, and each movement in the preset movement set is associated with animation. Accordingly, during the video call session, if any movement participating in the video call session is a movement in the preset movement set, animation corresponding to the movement is played back in the first video call session interface. The movement in the preset movement set may include gestures such as a peace gesture (that is, a V gesture made with two fingers) and a finger heart gesture. This is not specifically limited here. Animation associated with movements in the preset movement set may include, for example, fireworks animation, heart-shaped animation, and red envelope animation. This is not specifically limited here.

Sections A to C of FIG. 7 are schematic diagrams of playing back animation in a first video call session interface according to an embodiment of this application. As shown in section A of FIG. 7, in a case that a user does a peace gesture, a virtual object corresponding to the user in a first video call session interface also does the peace gesture, and fireworks animation corresponding to the peace gesture is played back in the first video call session interface. As shown in section B of FIG. 7, in a case that a user does a peace gesture, a virtual object corresponding to the user in a first video call session interface also does the peace gesture, and heart-shaped animation corresponding to the peace gesture is played back in the first video call session interface. As shown in section C of FIG. 7, in a case that a user does a peace gesture, a virtual object corresponding to the user in a first video call session interface also does the peace gesture, and red envelope animation corresponding to the peace gesture is played back in the first video call session interface.

In this embodiment, if the user (a first user or a second user) does a movement in the preset movement set, a corresponding virtual object in the first video call session interface is driven to present the movement, and animation associated with the movement is also presented in the first video call session interface, so that an interaction effect and user experience are improved.

In some embodiments, a plurality of display modes is provided in the first video call session interface, and the user may perform switching between different display modes according to specific needs. Specifically, the display mode includes a first display mode, a second display mode, and a third display mode. In the first display mode, the first virtual object and the second virtual object are in same virtual space, which is also be understood as the first virtual object and the second virtual object are in common virtual space, and a virtual background is the same.

Sections A to C of FIG. 8 are schematic diagrams of a first video call session interface according to an embodiment of this application. The first virtual object and the second virtual object are displayed in the first display mode in the first video call session interface shown in sections A to C in FIG. 8. In other words, the first virtual object and the second virtual object are in common virtual space. In this case, the first user drives the first virtual object to interact with the second virtual object, and the second user drives the second virtual object to interact with the first virtual object. Because the first virtual object and the second virtual object are in the same virtual space, for the user, face-to-face interaction between the first virtual object and the second virtual object is improved. For example, the first virtual object pinches the face of the second virtual object, and the first virtual object and the second virtual object hug. Accordingly, entertainment during the video call session can be improved, an immersive feeling is stronger, and user experience during the video call session is improved.

In the second display mode, the first virtual object and the second virtual object are displayed in parallel, and virtual space in which the first virtual object is located and virtual space in which the second virtual object is located are independent of each other. The second display mode may also be referred to as a parallel display mode. In this display mode, the first virtual object and the second virtual object have their own virtual space and virtual background. In this display mode, for the first client, the second client sends background data of the virtual space in which the second virtual object is located to the first client, and the first client renders a virtual background based on the background data of the virtual space in which the second virtual object is located, so as to display the virtual background of the second virtual object in the first video call session interface.

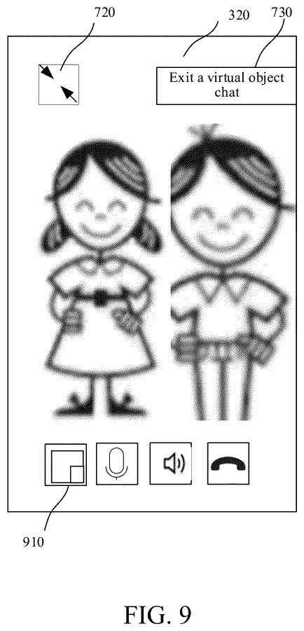

FIG. 9 is a schematic diagram of a first video call session interface according to another embodiment of this application. In FIG. 9, the first virtual object and the second virtual object are displayed in the second display mode in the first video call session interface. In a specific embodiment, in the second display mode, a screen displayed in the first video call session interface may be considered as being obtained by splicing two screens left and right. One of the two screens is a screen corresponding to the first virtual object, and the other is a screen corresponding to the second virtual object.

In the third display mode, the first virtual object and the second virtual object are located in different display windows in the first video call session interface, and a window size of a display window in which the first virtual object is located is different from a window size of a display window in which the second virtual object is located. In other words, in the third display mode, one of the first virtual object and the second virtual object in the first video call session interface is displayed in a large display window, and the other one of the first virtual object and the second virtual object in the first video call session interface is displayed in a small display window. More specifically, the two display windows may be displayed in an overlapping manner, that is, a small display window is overlapped on a large display window. The large display window may be a full screen window of a display screen of the first terminal, and the small display window may be a display window with an area smaller than the full screen window, overlapped on the full screen window.

In some embodiments, in the third display mode, the virtual object corresponding to the client may be displayed in the large display window by default, so that a virtual object corresponding to another client participating in the video call session may be displayed in the small display window. For example, in the first video call session interface at the first client side, the first virtual object is displayed in the large display window, and the second virtual object is displayed in the small display window.

In some other embodiments, in the third display mode, a virtual object corresponding to another client may be displayed in the large display window by default, so that a virtual object corresponding to a client currently used by the user may be displayed in the small display window. For example, in the first video call session interface at the first client side, the second virtual object is displayed in the large display window, and the first virtual object is displayed in the small display window.

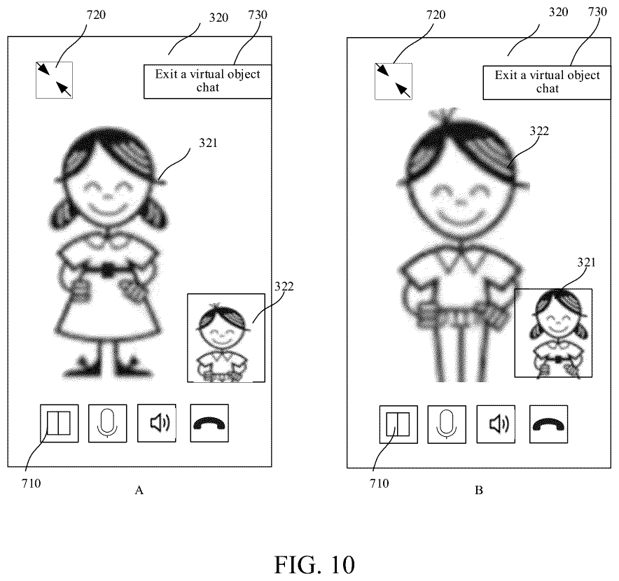

FIG. 10 is a schematic diagram of a first video call session interface according to another embodiment of this application. In the first video call session interfaces shown in sections A and B of FIG. 10, the first virtual object and the second virtual object are displayed in the third display mode. It is assumed that section A of FIG. 10 shows the first video call session interface displayed on a first client. In this case, a first virtual object 321 is displayed in a large display window, and a second virtual object 322 is displayed in a small display window. Further, a user may trigger a display window switching operation to display the first virtual object 321 in the small display window and display the second virtual object 322 in the large display window. In this case, the first video call session interface is shown in section B of FIG. 10. The display window switching operation may be an operation triggered at any position in the large display window, such as a click/tap operation or a touch operation. This is not specifically limited here.

In some embodiments, after an initial video call session is established, the first virtual object and the second virtual object may be displayed in a default display mode in the first video call session interface. The default display mode may be any of the first display mode, the second display mode, and the third display mode, which may be provided based on specific needs. For example, the default display mode is the third display mode.

In some embodiments, a first mode control is included in the first video call session interface. The method further includes: displaying, in the first video call session interface, the first virtual object and the second virtual object in a first display mode in response to a trigger operation on the first mode control.

The first mode control is a control configured to indicate to perform display in the first display mode in the first video call session interface. In some embodiments, in a case that a display mode in the first video call session interface is not the first display mode (for example, the third display mode or the second display mode), the first mode control is displayed in the first video call session interface, so that the user triggers the first mode control to switch to the first display mode.

In some other embodiments, a selection entry for display mode selection may be provided in the first video call session interface, so that the user triggers the selection entry, display modes that can be selected by the user (such as displaying the first display mode, the second display mode, and the third display mode mentioned above) are displayed. If the user selects the first display mode, the interface is switched to display the first virtual object and the second virtual object in the first display mode.

In some embodiments, a second mode control is included in the first video call session interface, and the method further includes: displaying, in the first video call session interface, the first virtual object and the second virtual object in a second display mode in response to a trigger operation on the second mode control.

The second mode control is a control configured to perform display in the second display mode in the first video call session interface. In some embodiments, in a case that a display mode in the first video call session interface is not the second display mode, the second mode control is displayed in the first video call session interface, so that the user switches the display mode to the second display mode by triggering the second mode control. For example, a second mode control 910 is displayed in the first video call session interface shown in FIG. 8 and FIG. 9. If the user triggers the second mode control 910, the interface may be switched to display the virtual objects in the second display mode.

In some embodiments, a third mode control is included in the first video call session interface, and the method further includes: displaying, in the first video call session interface, the first virtual object and the second virtual object in a third display mode in response to a trigger operation on the third mode control.

The third mode control is a control configured to perform display in the third display mode in the first video call session interface. In some embodiments, in a case that a display mode in the first video call session interface is not the third display mode, the third mode control is displayed in the first video call session interface, so that the user switches the display mode to the third display mode by triggering the third mode control. A third mode control 710 is displayed in the first video call session interface of FIG. 7 and FIG. 10. If the user triggers the third mode control 710, the third display mode is switched to correspondingly.

In some other embodiments, a mode switching control is included in the first video call session interface, and the method further includes: switching a display mode of the first virtual object and the second virtual object in the first video call session interface in response to a trigger operation on the mode switching control. In a specific embodiment, switching is performed between a plurality of display modes according to a preset switching order, that is, a next display mode of a current display mode in the preset switching order may be determined according to the preset switching order and the current display mode, and the interface is switched to display the virtual objects in the next display mode. The display mode is, for example, the first display mode, the second display mode, or the third display mode, and the preset switching order is a cyclic switching order, such as the third display mode→the second display mode→the first display mode→the third display mode. To be specific, if a display mode of the first user and the second user in a current first video call session interface is the second display mode, if the mode switching control is triggered, switching is performed to display the virtual objects in the first display mode. If the display mode in the current first video call session interface is the third display mode, if the mode switching control is triggered, switching is performed to display the virtual objects in the second display mode. Therefore, a mode switching control is configured to perform switching between the plurality of display modes, which can prevent more controls in the first video call session interface from blocking the first user or the second user.

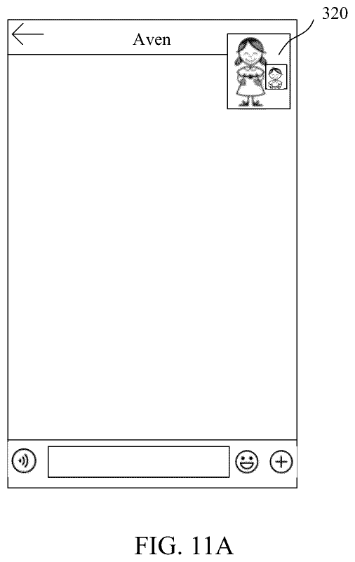

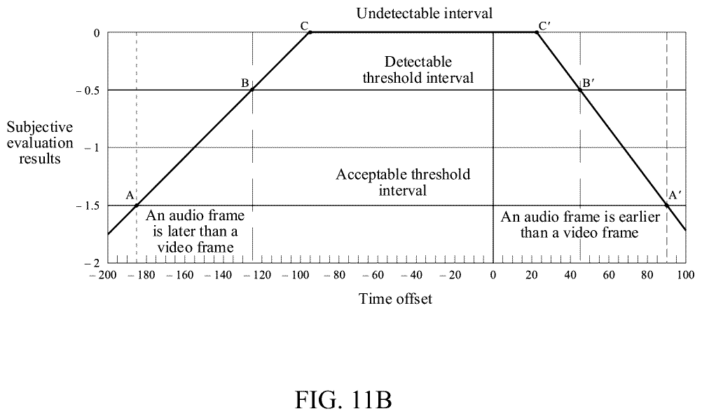

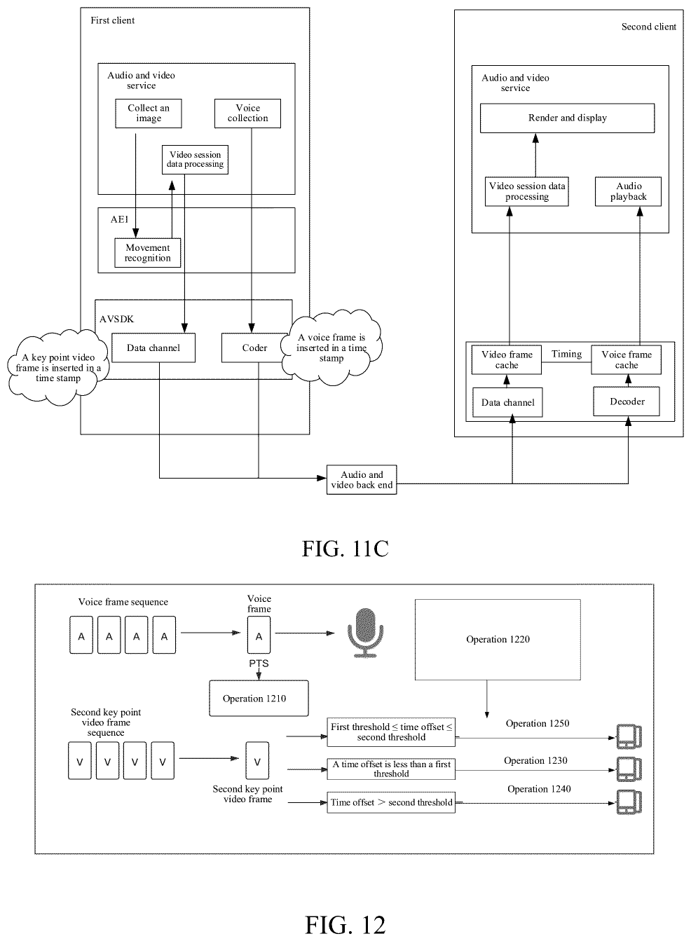

In some embodiments, a zoomed-out control is included in the first video call session interface, and the method further includes: displaying the first video call session interface in a zoomed-out manner in response to a trigger operation on the zoomed-out control. A zoomed-out first video call session interface may be displayed, in an overlapped manner, on another user interface in the form of a floating window. FIG. 11A is a schematic diagram of displaying a first video call session interface in a zoomed-out manner according to an embodiment of this application. In FIG. 11A, a first video call session interface 320 is displayed, in an overlapped manner, on another user interface in the form of a floating window. The first video call session interface shown in FIG. 7 to FIG. 10 shows a zoomed-out control 720. If the user triggers the zoomed-out control, the first video call session interface may be displayed in a zoomed-out manner.

In some embodiments, a first control is included in the first video call session interface. The method further includes: exiting the first video call session interface in response to a trigger operation on the first control.

The first control is a control configured to exit a session mode of a video call session by using a virtual object. If the user triggers the first control, the first video call session interface is not displayed in the screen. In some embodiments, if initial switching is performed from another session mode (such as a voice session mode or a regular video call session mode) to a video call session mode by using a virtual object for a video call session, if the user triggers the first control in the first video call session interface, after the first video call session interface is exited, a session interface corresponding to the previous session mode is displayed. For example, if switching is performed from a voice session mode to a video call session mode by using a virtual object for a video call session, if a trigger operation on the first control is detected, the first video call session interface is exited, and the voice session interface is displayed. For another example, if switching is performed from a regular video call session mode to a video call session mode by using a virtual object for a video call session, if a trigger operation on the first control is detected, the first video call session interface is exited, and the regular video call session interface is displayed. In the regular video call session interface, the first image collected by the first terminal and the second image collected by the second terminal are displayed. In this embodiment, switching may be performed flexibly between different session modes by triggering the first control. A first control 730 is shown in the first video call session interface shown in FIG. 7 to FIG. 10.

In some scenarios, a problem of sound and screen asynchrony may occur during a video call session due to a network condition. Studies have shown that different time offsets in the sound and screen asynchrony bring different user experience. FIG. 11B is an example curve of impacts of sound and screen asynchrony on human body's subjective experience and feelings under different time offsets. The time offset (delay) is a difference between time corresponding to a voice frame and time corresponding to a video frame. It can be seen from FIG. 11B that a time offset between the voice frame and the video frame ranges from 100 ms to 25 ms, and the user does not feel a significant voice and screen difference.

To make the difference between sound and picture not excessively large to cause significant physical discomfort to the user, a time stamp may be added to the video call session data and voice data transmitted between the first terminal and the second terminal. After receiving the video call session data and voice data, the recipient may perform timing based on the time stamp carried by the video call session data and the time stamp carried by the voice data. FIG. 11C is a flowchart of processing data between a sender and a recipient according to an embodiment of this application. As shown in FIG. 11C, the time stamp is inserted in the video call session data and the time stamp is inserted in the voice data at the sender, before sending. When the recipient receives the video call session data and the voice data, timing is performed based on the time stamp in the video call session data and the time stamp in the voice data. A specific timing process may be shown in operation 1230 to operation 1250 in FIG. 12.

Specifically, a second key point video frame corresponding to the second user carries a first time stamp. The first time stamp may be configured for indicating a moment corresponding to the second key point video frame when the second image is collected. In this embodiment, as shown in FIG. 12, operation A2 includes the following operation 1210 to operation 1250. A detailed description is as follows:

Operation 1210: Calculate a difference between a first time stamp and a second time stamp carried by a voice frame from the second client to obtain a time offset.

Operation 1220: Perform screen rendering based on the second key point video frame and model data of the second virtual object to obtain a virtual object screen, the second virtual object in the virtual object screen presenting the second movement.

If a time offset is less than the first threshold, operation 1230 is performed. In the first video call session interface, the virtual object screen is played back at a first playback rate, the first playback rate being greater than a default playback rate of the virtual object screen. The first threshold may be less than zero, for example, the first threshold is −25 ms. At this time, the voice frame is earlier than the key point video frame, and the key point video frame is later than the voice frame. In this case, playing back a virtual object screen at a first playback rate is equivalent to allowing the current virtual object screen to be displayed as soon as possible.

In a specific embodiment, when the time offset is less than the first threshold, a preset delay is determined based on a default playback rate. The preset delay is a playback time difference between two adjacent screen frames determined based on the default playback rate. Then, adjustment is performed based on the preset delay. An adjusted playback delay is a lager value between 0 and a second delay, and the second delay is equal to the sum of the preset delay and the time offset. Then, the virtual object screen is played back based on the adjusted playback delay.

In some embodiments, the method further includes: discarding the second key point video frame if time offsets corresponding to a consecutive preset quantity of historical key point video frames before the second key point video frame are all less than the first threshold. In this case, if the time offsets corresponding to consecutive multi-frame key point video frames are less than the first threshold, the current key point video frame is discarded, that is, rendering is not needed to be performed based on the current key point video frame, and a next key point video frame is rendered directly to catch up with the audio frame as soon as possible and reduce the delay between the key point video frame and the audio frame.

If the time offset is greater than a second threshold, operation 1240 is performed. Playback of the virtual object screen is delayed in the first video call session interface. The second threshold is greater than the first threshold. The second threshold may be greater than zero, for example, 100 ms. When the time offset is greater than the second threshold, it indicates that the key point video frame is faster than the voice frame. In this case, playback of the virtual object screen is delayed, so that the time difference between the key point video frame and the voice frame can be reduced. In a specific embodiment, the virtual object screen may be delayed based on preset delay time.

If the time offset is greater than or equal to the first threshold and not less than or equal to the second threshold, operation 1250 is performed. The virtual object screen is played back at the default playback rate, that is, play back the virtual object screen normally. For example, the virtual object screen is played back based on the preset delay at the default playback rate.

Based on this embodiment, the virtual object screen is delayed or played back as soon as possible depending on different delay conditions, so as to reduce impact of sound and screen asynchrony on the user experience, effectively ensure the user experience in the video call session process, and improve the playability, reliability and fluency of a driving virtual image.

The following describes apparatus embodiments of this application, and the apparatus embodiments may be used for performing the method in the foregoing embodiment of this application. For details not disclosed in the apparatus embodiments of this application, refer to the foregoing method embodiments of this application.

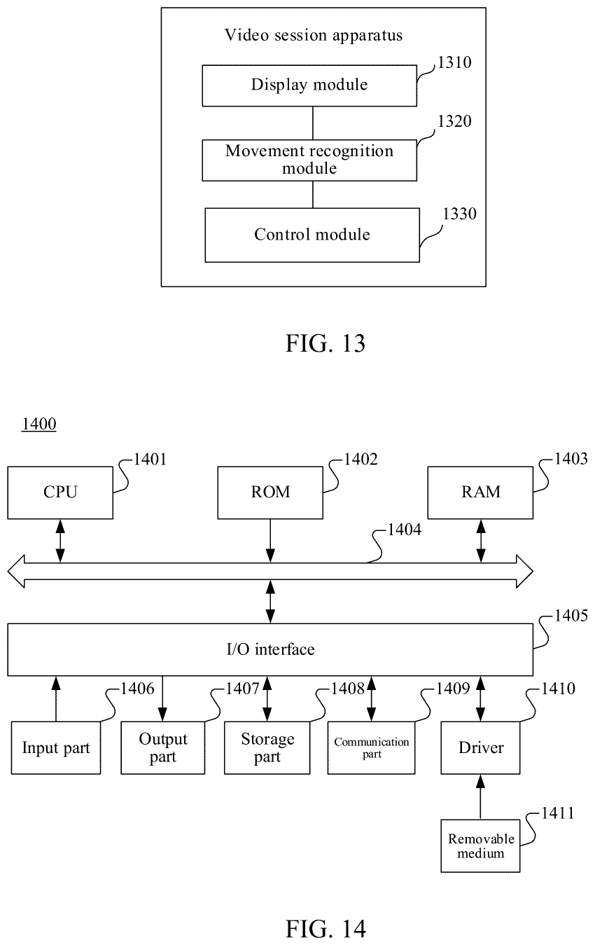

FIG. 13 is a block diagram of a video call session apparatus according to an embodiment of this application. The video call session apparatus may be configured on the first terminal in which a first client participating in a video call session is located. As shown in FIG. 13, the video call session apparatus includes:
a display module 1310, configured to display a first video call session interface on a first client participating in a video call session, a first virtual object corresponding to the first client being included in the first video call session interface;
a movement recognition module 1320, configured to recognize a first movement of a first user in a first image, the first image being an image collected by a first terminal when the first terminal faces the first user; and
a control module 1330, configured to control the first virtual object in the first video call session interface to perform the first movement.

In some embodiments, a client participating in the video call session further includes a second client on a second terminal. After the recognizing a first movement of a first user in a first image, the second terminal controls the first virtual object in a second video call session interface displayed in the second client to perform the first movement.

In some embodiments, a client participating in the video call session further includes a second client on a second terminal. After the recognizing a first movement of a first user in a first image, the second terminal controls a first virtual object in a second video call session interface displayed in the second client to perform the first movement, and controls a second virtual object that is in the second video call session interface and that corresponds to the second client to respond to the first movement.

In some embodiments, the video call session apparatus further includes:
a first playback module, configured to play back, in the first video call session interface, animation corresponding to the first movement.

In some embodiments, a client participating in the video call session further includes a second client on a second terminal. A second virtual object corresponding to the second client is also included in the first video call session interface. The video call session apparatus further includes:
a receiving module, configured to:
receive second video call session data of the second client, the second video call session data including a second key point video frame corresponding to a second user, the second key point video frame being obtained by performing key point extraction on the second user in a second image, the second image being an image collected by the second terminal when the second terminal faces the second user during the video call session, and the second key point video frame being configured for indicating a second movement of the second user in the second image, the control module 1330 being further configured to control, based on the second key point video frame, the second virtual object in the first video call session interface to perform the second movement.

In some embodiments, the video call session apparatus further includes: an animation playback module, configured to play back animation corresponding to the second movement in the first video call session interface if the second movement is a movement in a preset movement set.

In some embodiments, the movement recognition module 1320 includes:
a key point extraction unit, configured to perform key point extraction on the first user in the first image to obtain a first key point video frame corresponding to the first user; and
a movement determining unit, configured to determine the first movement based on the first key point video frame.

In some embodiments, a client participating in the video call session further includes a second client on a second terminal. A second virtual object corresponding to the second client and a first mode control are also included in the first video call session interface. The video call session apparatus further includes:
a first mode display module, configured to display, in the first video call session interface, the first virtual object and the second virtual object in a first display mode in response to a trigger operation on the first mode control; in the first display mode, the first virtual object and the second virtual object being in same virtual space.

In some embodiments, a client participating in the video call session further includes a second client on a second terminal. A second virtual object corresponding to the second client and a second mode control are also included in the first video call session interface. The video call session apparatus further includes:
a second mode display module, configured to display, in the first video call session interface, the first virtual object and the second virtual object in a second display mode in response to a trigger operation on the second mode control; in the second display mode, the first virtual object and the second virtual object being displayed in parallel, and virtual space in which the first virtual object is located and virtual space in which the second virtual object is located being independent of each other.

In some embodiments, a client participating in the video call session further includes a second client on a second terminal. A second virtual object corresponding to the second client and a third mode control are also included in the first video call session interface. The video call session apparatus further includes:
a third mode display module, configured to display, in the first video call session interface, the first virtual object and the second virtual object in a third display mode in response to a trigger operation on the third mode control; in the third display mode, the first virtual object and the second virtual object being located in different display windows in the first video call session interface, and a window size of a display window in which the first virtual object is located being different from a window size of a display window in which the second virtual object is located.

In some embodiments, a client participating in the video call session further includes a second client on a second terminal. A second virtual object corresponding to the second client and a mode switching control are also included in the first video call session interface. The video call session apparatus further includes:
a mode switching module, configured to switch a display mode of the first virtual object and the second virtual object in the first video call session interface in response to a trigger operation on the mode switching control.

In some embodiments, the video call session apparatus further includes:
a fourth mode display module, configured to display an initial session interface in response to a session initiation operation initiated to the second client, an entry control being included in the initial session interface; and display the first video call session interface in response to a trigger operation on the entry control.

In some embodiments, the second key point video frame carries a first time stamp. In this embodiment, the control module 1330 includes:
a rendering unit, configured to perform screen rendering based on the second key point video frame and model data of the second virtual object to obtain a virtual object screen, the second virtual object in the virtual object screen presenting the second movement;
a first playback unit, configured to playback, in the first video call session interface, the virtual object screen at a first playback rate if a time offset is less than a first threshold, the first playback rate being greater than a default playback rate of the virtual object screen, and the time offset being equal to a difference between the first time stamp and a second time stamp carried by a voice frame from the second client;
a second playback unit, configured to delay playback of the virtual object screen in the first video call session interface if the time offset is greater than a second threshold, the second threshold being greater than the first threshold; and
a third playback unit, configured to play back the virtual object screen at the default playback rate if the time offset is not less than the first threshold and is not greater than the second threshold.

In some embodiments, the video call session apparatus further includes:
a discard module, configured discard the second key point video frame if time offsets corresponding to a consecutive preset quantity of historical key point video frames before the second key point video frame are all less than the first threshold.

In some embodiments, the video call session apparatus further includes:
a network status determining module, configured to determine a network status of the first terminal; and
an encoding module, configured to encode the first key point video frame to obtain first video call session data corresponding to the first client.

In this embodiment, the sending module is further configured to: perform, according to an anti-packet loss strategy corresponding to the network status, data transmission protection on video call session data and voice data transmitted between the first terminal and the second terminal in which the second client is located.

FIG. 14 is a schematic diagram of a structure of an electronic device for implementing an embodiment of this application. The electronic device may be a terminal in which a first client is located, such as a smartphone, a tablet computer, a notebook computer, a smart television, or a desktop computer. The electronic device may be configured to perform the method for video call session provided in this application. The electronic device 1400 shown in FIG. 14 is merely an example, and may not bring any limitation to the functions and use ranges of some embodiments.

As shown in FIG. 14, the electronic device 1400 includes a central processing unit (CPU) 1401, which may perform various suitable actions and processing based on a program stored in a read-only memory (ROM) 1402 or a program loaded from a storage part 1408 into a random access memory (RAM) 1403, for example, perform the method described in the foregoing embodiments. The RAM 1403 further has various programs and data required for system operations stored therein. The CPU 1401, the ROM 1402, and the RAM 1403 are connected to each other via a bus 1404. An input/output (I/O) interface 1405 is also connected to the bus 1404.

The following components are connected to the I/O interface 1405: an input part 1406 including a keyboard, a mouth, and the like; an output part 1407 including, for example, a cathode ray tube (CRT), a liquid crystal display (LCD), and a speaker; a storage part 1408 including a hard disk and the like; and a communication part 1409 including, for example, a local area network (LAN) card, a modem, and another network interface card. The communication part 1409 performs communication processing by using a network such as the Internet. A driver 1410 is also connected to the I/O interface 1405 as required. A removable medium 1411, such as a magnetic disk, an optical disc, a magneto-optical disk, or a semiconductor memory, is installed on the driver 1410 as required, so that a computer program read from the removable medium is installed into the storage part 1408 as required.

Particularly, according to an embodiment of this application, the processes described above by referring to the flowcharts may be implemented as computer software programs. For example, some embodiments includes a computer program product, the computer program product includes a computer program carried on a computer-readable medium, and the computer program includes program code used for performing the methods shown in the flowcharts. In such an embodiment, the computer program may be downloaded and installed from a network by using a communication part 1409, and/or installed from a removable medium 1411. When the computer program is executed by the CPU 1401, the various functions defined in the system of this application are executed.

The computer-readable medium shown in embodiments of this application may be a computer-readable signal medium, a computer-readable storage medium, or any combination thereof. The computer-readable storage medium may be, for example, but is not limited to, an electric, magnetic, optical, electromagnetic, infrared, or semi-conductive system, apparatus, or component, or any combination thereof. A more specific example of the computer-readable storage medium may include but is not limited to: an electrical connection with one or more wires, a portable computer disk, a hard disk, a random access memory (RAM), a read-only memory (ROM), an erasable programmable read only memory (EPROM), a flash memory, an optical fiber, a portable compact disc read-only memory (CD-ROM), an optical storage device, a magnetic storage device, or any appropriate combination thereof. In some embodiments, the computer-readable storage medium may be any tangible medium including or storing a program, and the program may be used by or used in combination with an instruction execution system, an apparatus, or a device. In some embodiments, a computer-readable signal medium may include a data signal being in a baseband or propagated as a part of a carrier wave, the data signal carrying computer-readable program code. A data signal propagated in such a way may assume a plurality of forms, including, but not limited to, an electromagnetic signal, an optical signal, or any appropriate combination thereof. The computer-readable signal medium may be further any computer-readable medium in addition to a computer-readable storage medium. The computer-readable medium may send, propagate, or transmit a program that is used by or used in conjunction with an instruction execution system, an apparatus, or a device. The program code included in the computer-readable medium may be transmitted by using any suitable medium, including but not limited to: a wireless medium, a wired medium, and the like, or any appropriate combination thereof.

The flowcharts and block diagrams in the accompanying drawings illustrate possible system architectures, functions and operations that may be implemented by a system, a method, and a computer program product according to various embodiments of this application. Each box in a flowchart or a block diagram may represent a module, a program segment, or a part of code. The module, the program segment, or the part of code includes one or more executable instructions used for implementing specified logic functions. In some implementations used as substitutes, functions annotated in boxes may alternatively occur in a sequence different from that annotated in an accompanying drawing. For example, two boxes shown in succession may be performed basically in parallel, and sometimes the two boxes may be performed in a reverse sequence. This is determined by a related function. Each box in a block diagram or a flowchart and a combination of boxes in the block diagram or the flowchart may be implemented by using a dedicated hardware-based system configured to perform a specified function or operation, or may be implemented by using a combination of dedicated hardware and a computer instruction.

A related unit described in embodiments of this application may be implemented in a software manner, or may be implemented in a hardware manner, and the unit described can also be provided in a processor. Names of the units do not constitute a limitation on the units in a specific case.

According to another aspect, this application further provides a computer-readable storage medium. The computer-readable medium may be included in the electronic device described in the foregoing embodiments, or may exist alone and is not disposed in the electronic device. The computer-readable storage medium carries computer-readable instructions, the computer-readable instructions, when executed by the processor, implementing the method in any one of the foregoing embodiments.

According to an aspect of this application, an electronic device is further provided and includes: a processor; and a memory, having computer-readable instructions, the computer-readable instructions, when executed by the processor, implementing the method in any one of the foregoing embodiments.

According to an aspect of embodiments of this application, a computer program product or a computer program is provided. The computer program product or the computer program includes computer instructions. The computer instructions are stored in a computer-readable storage medium. A processor of a computer device reads the computer instructions from the computer-readable storage medium, and the processor executes the computer instructions, so that the computer device performs the method in any one of the foregoing embodiments.

Although a plurality of modules or units of a device configured to perform movements are discussed in the foregoing detailed description, such division is not mandatory. According to the implementations of this application, the features and functions of two or more modules or units described above may be specifically implemented in one module or unit. In contrast, the features and functions of one module or unit described above may be further divided to be specifically implemented in a plurality of modules or units.

According to the foregoing descriptions of the implementations, a person skilled in the art may readily understand that the embodiments described herein may be implemented by using software, or may be implemented by combining software and necessary hardware. Therefore, the technical solutions of implementations of this application may be implemented in the form of a software product. The software product may be stored in a non-volatile storage medium (which may be a CD-ROM, a USB flash drive, a removable hard disk, or the like) or on the network, including a plurality of instructions for instructing a computing device (which may be a personal computer, a server, a touch terminal, a network device, or the like) to perform the method according to embodiments of this application.

After considering the specification and practicing the disclosed implementations, a person skilled in the art may easily conceive of other implementations of this application. This application is intended to cover any variations, uses, or adaptive changes of this application. These variations, uses, or adaptive changes follow the general principles of this application and include common general knowledge or common technical means in the art, which are not disclosed in this application.

This application is not limited to the precise structures described above and shown in the accompanying drawings, and various modifications and changes can be made without departing from the scope of this application. The scope of this application is subject only to the appended claims.

What is claimed is:

1. A method for facilitating a video call session, performed by a first terminal, the method comprising:
displaying a first video call session interface on a first client participating in a video call session, a first virtual object corresponding to the first client in the first video call session interface;
recognizing a first movement of a first user in a first image, the first image being an image collected by the first terminal when the first terminal faces the first user; and
controlling the first virtual object in the first video call session interface to perform the first movement.

2. The method according to claim 1, wherein a client participating in the video call session further comprises a second client on a second terminal; and after the recognizing a first movement of a first user in a first image, the second terminal controls a first virtual object in a second video call session interface displayed in the second client to perform the first movement.

3. The method according to claim 1, wherein a client participating in the video call session further comprises a second client on a second terminal; and after the recognizing a first movement of a first user in a first image, the second terminal controls a first virtual object in a second video call session interface displayed in the second client to perform the first movement, and controls a second virtual object that is in the second video call session interface and that corresponds to the second client to respond to the first movement.

4. The method according to claim 1, wherein after the recognizing a first movement of a first user in a first image, the method further comprises:
playing back, in the first video call session interface, animation corresponding to the first movement.

5. The method according to claim 1, wherein a client participating in the video call session further comprises a second client on a second terminal; and a second virtual object corresponding to the second client being also comprised in the first video call session interface; and
after the displaying a first video call session interface on a first client participating in a video call session, the method further comprises:
receiving second video call session data of the second client, the second video call session data comprising a second key point video frame corresponding to a second user, the second key point video frame being obtained by performing key point extraction on the second user in a second image, the second image being an image collected by the second terminal when the second terminal faces the second user during the video call session, and the second key point video frame being configured for indicating a second movement of the second user in the second image; and
controlling, based on the second key point video frame, the second virtual object in the first video call session interface to perform the second movement.

6. The method according to claim 5, further comprising:
playing back animation corresponding to the second movement in the first video call session interface if the second movement is a movement in a preset movement set.

7. The method according to claim 1, wherein the recognizing a first movement of a first user in a first image comprises:
performing key point extraction on the first user in the first image to obtain a first key point video frame corresponding to the first user; and
determining the first movement based on the first key point video frame.

8. The method according to claim 1, wherein a client participating in the video call session further comprises a second client on a second terminal; a second virtual object corresponding to the second client and a first mode control are also comprised in the first video call session interface; and the method further comprises:
displaying, in the first video call session interface, the first virtual object and the second virtual object in a first display mode in response to a trigger operation on the first mode control; in the first display mode, the first virtual object and the second virtual object being in same virtual space.

9. The method according to claim 1, wherein a client participating in the video call session further comprises a second client on a second terminal; a second virtual object corresponding to the second client and a second mode control are also comprised in the first video call session interface; and the method further comprises:
displaying, in the first video call session interface, the first virtual object and the second virtual object in a second display mode in response to a trigger operation on the second mode control; in the second display mode, the first virtual object and the second virtual object being displayed in parallel, and virtual space in which the first virtual object is located and virtual space in which the second virtual object is located being independent of each other.

10. The method according to claim 1, wherein a client participating in the video call session further comprises a second client on a second terminal; a second virtual object corresponding to the second client and a third mode control are also comprised in the first video call session interface; and the method further comprises:
displaying, in the first video call session interface, the first virtual object and the second virtual object in a third display mode in response to a trigger operation on the third mode control; in the third display mode, the first virtual object and the second virtual object being located in different display windows in the first video call session interface, and a window size of a display window in which the first virtual object is located being different from a window size of a display window in which the second virtual object is located.

11. The method according to claim 1, wherein a client participating in the video call session further comprises a second client on a second terminal; a second virtual object corresponding to the second client and a mode switching control are also comprised in the first video call session interface; and the method further comprises:
switching a display mode of the first virtual object and the second virtual object in the first video call session interface in response to a trigger operation on the mode switching control.

12. The method according to claim 1, wherein a client participating in the video call session further comprises a second client on a second terminal; before the displaying a first video call session interface on a first client participating in a video call session, the method further comprises:
displaying an initial session interface in response to a session initiation operation initiated to the second client, an entry control in the initial session interface; and
the displaying a first video call session interface on a first client participating in a video call session comprises:
displaying the first video call session interface in response to a trigger operation on the entry control.

13. The method according to claim 5, wherein the second key point video frame carries a first time stamp;
the controlling, based on the second key point video frame, the second virtual object in the first video call session interface to perform the second movement comprises:
performing screen rendering based on the second key point video frame and model data of the second virtual object to obtain a virtual object screen, the second virtual object in the virtual object screen presenting the second movement;
playing back, in the first video call session interface, the virtual object screen at a first playback rate if a time offset is less than a first threshold, the first playback rate being greater than a default playback rate of the virtual object screen, and the time offset being equal to a difference between the first time stamp and a second time stamp carried by a voice frame from the second client;
delaying playback of the virtual object screen in the first video call session interface if the time offset is greater than a second threshold, the second threshold being greater than the first threshold; and
playing back the virtual object screen at the default playback rate if the time offset is not less than the first threshold and is not greater than the second threshold.

14. The method according to claim 13, further comprising:
discarding the second key point video frame if time offsets corresponding to a consecutive preset quantity of historical key point video frames before the second key point video frame are all less than the first threshold.

15. The method according to claim 7, wherein after the performing key point extraction on the first user in the first image to obtain a first key point video frame corresponding to the first user, the method further comprises:
encoding the first key point video frame to obtain first video call session data corresponding to the first client; and
sending the first video call session data to the second client.

16. The method according to claim 15, further comprising:
determining a network status of the first terminal; and
performing, according to an anti-packet loss strategy corresponding to the network status, data transmission protection on video call session data and voice data transmitted between the first terminal and the second terminal in which the second client is located.

17. An electronic device, comprising:
a processor; and
a memory, having computer-readable instructions stored therein, the computer-readable instructions, when executed by the processor, implementing a method for facilitating a video call session, performed by a first terminal, the method comprising:
displaying a first video call session interface on a first client participating in a video call session, a first virtual object corresponding to the first client in the first video call session interface;
recognizing a first movement of a first user in a first image, the first image being an image collected by the first terminal when the first terminal faces the first user; and
controlling the first virtual object in the first video call session interface to perform the first movement.

18. The electronic device according to claim 17, wherein a client participating in the video call session further comprises a second client on a second terminal; and after the recognizing a first movement of a first user in a first image, the second terminal controls a first virtual object in a second video call session interface displayed in the second client to perform the first movement.

19. A non-transitory computer-readable storage medium, having computer-readable instructions stored thereon, the computer-readable instructions, when executed by a processor, implementing a method for facilitating a video call session, performed by a first terminal, the method comprising:
displaying a first video call session interface on a first client participating in a video call session, a first virtual object corresponding to the first client in the first video call session interface;
recognizing a first movement of a first user in a first image, the first image being an image collected by the first terminal when the first terminal faces the first user; and
controlling the first virtual object in the first video call session interface to perform the first movement.

20. The computer-readable storage medium according to claim 19, wherein a client participating in the video call session further comprises a second client on a second terminal; and after the recognizing a first movement of a first user in a first image, the second terminal controls a first virtual object in a second video call session interface displayed in the second client to perform the first movement.
